(19) United States
(12) Patent Application Publication
(10) Pub. No.: US 2025/0137680 A1
(43) Pub. Date: May 1, 2025

(54) AIR CONDITIONER

(71) Applicant: Mitsubishi Electric Corporation, Tokyo (JP)

(72) Inventors: Shun MIYAMORI, Tokyo (JP); Ikumi HOSHINO, Tokyo (JP)

(21) Appl. No.: 18/690,776

(22) PCT Filed: Jan. 26, 2022
(86) PCT No.: PCT/JP2022/002862

§ 371 Date: Mar. 11, 2024

(51) Int. Cl. F24F 11/88

(52) U.S. Cl. CPC F24F 11/88

(57) ABSTRACT

An air conditioner includes an indoor unit and an outdoor unit. The air conditioner includes a relay that is in one of a short-circuit state or a released state according to a switching signal to be supplied, a voltage detection circuit that detects a voltage, and a relay switching circuit that outputs a switching signal for causing the relay to be in the released state in a case where a value of the voltage detected by the voltage detection circuit is larger than a predetermined first threshold, to the relay. The relay, the voltage detection circuit, and the relay switching circuit are disposed in the indoor unit or the outdoor unit.

### CROSS REFERENCE TO RELATED APPLICATION

This application is a U.S. national stage application of PCT/JP2022/002862 filed on Jan. 26, 2022, the contents of which are incorporated herein by reference.

### FIELD

The present disclosure relates to an air conditioner.

### BACKGROUND

When products are used, although it is desirable to use the products under a stable power supply voltage, there are still many regions overseas where the power supply voltage is unstable. Therefore, an abnormal power supply voltage may be applied to the product. By installing a stabilizer, it is possible to stabilize the power supply voltage and apply a stable voltage to the products.

However, the stabilizer is sold separately from the products, and a price of the stabilizer is different from the price of the product. If the product has a protective function equivalent to a protective function of the stabilizer, it is not needed to purchase the stabilizer.

In a case where the product has the protective function equivalent to the protective function of the stabilizer, even if an overvoltage having an overvoltage interruption value designed for the product in advance is applied to the product, the product can interrupt the overvoltage by a substrate and protect itself so that an overvoltage having a value equal to or more than the overvoltage interruption value is not applied.

Typically, an air conditioner that determines an anomaly of a commercial power supply has been proposed (for example, refer to Patent Literature 1).

### PATENT LITERATURE

Patent Literature 1: International Publication Pamphlet No. WO 2008/146923

In the related art, since application of a voltage to a driving unit is interrupted via a microcomputer in a case where an overvoltage is detected, it takes relatively long time before the driving unit is protected, and there is a possibility that a component disposed on a substrate is destroyed by an abnormal voltage before the driving unit is protected.

### SUMMARY

The present disclosure has been made in view of the above, and an object of the present disclosure is to obtain an air conditioner that shortens time from detection of an overvoltage to interruption of application of the overvoltage.

In order to solve the above-described problems and achieve the object, an air conditioner according to the present disclosure includes an indoor unit and an outdoor unit. The air conditioner according to the present disclosure includes: a switch that is in one of a short-circuit state or a released state according to a switching signal to be supplied; a voltage detection circuit that detects a voltage and outputs a voltage signal indicating a voltage value obtained by the detection; a switch switching circuit that outputs a switching signal for causing the switch to be in the released state in a case where a value indicated by the voltage signal output from the voltage detection circuit is larger than a predetermined first threshold, to the switch; and a central processing unit that outputs a driving signal for driving the switch switching circuit to the switch switching circuit. The switch, the voltage detection circuit, and the switch switching circuit are disposed in the outdoor unit. The voltage signal is output to the switch switching circuit without passing through the central processing unit.

An air conditioner according to the present disclosure achieves an effect for shortening time from detection of an overvoltage to interruption of application of the overvoltage.

### BRIEF DESCRIPTION OF DRAWINGS

FIG. 1 is a diagram illustrating a configuration of an air conditioner according to a first embodiment.

FIG. 2 is a diagram illustrating a configuration of an external protection relay switching circuit included in an outdoor unit of the air conditioner according to the first embodiment.

FIG. 3 is a flowchart illustrating a procedure of an operation performed by the air conditioner according to the first embodiment.

FIG. 4 is a diagram illustrating a configuration of an air conditioner according to a second embodiment.

FIG. 5 is a flowchart illustrating a procedure of an operation performed by the air conditioner according to the second embodiment.

### DETAILED DESCRIPTION

Hereinafter, an air conditioner according to embodiments will be described in detail with reference to the drawings.

### First Embodiment

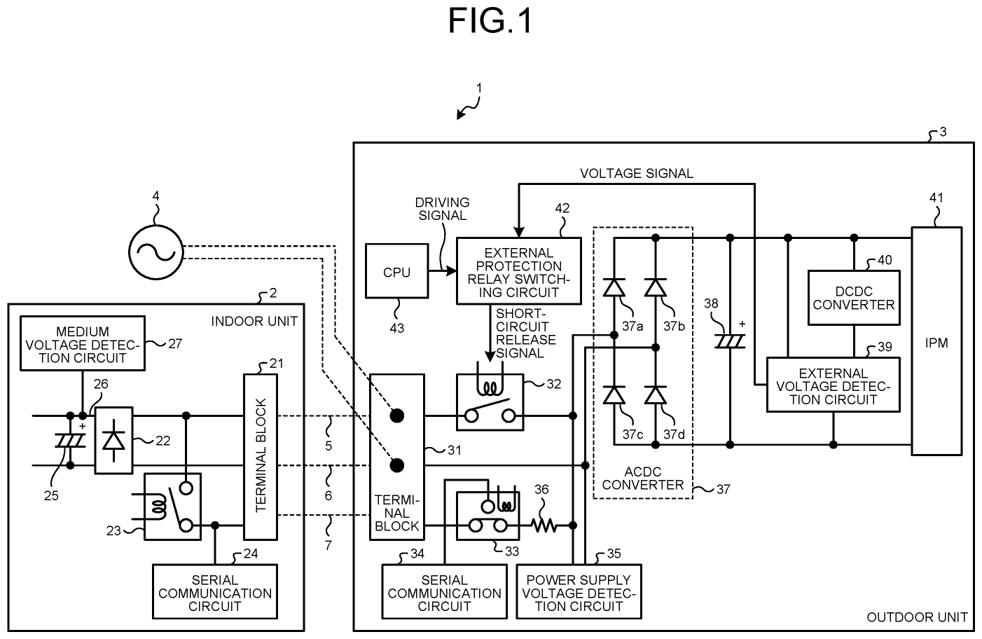

FIG. 1 is a diagram illustrating a configuration of an air conditioner 1 according to a first embodiment. The air conditioner 1 includes an indoor unit 2 and an outdoor unit 3. An input power supply 4 that is an AC power supply is connected to the indoor unit 2 and the outdoor unit 3. In FIG. 1, the input power supply 4 is also illustrated.

The indoor unit 2 includes a terminal block 21 connected to the outdoor unit 3, a diode 22 connected to the terminal block 21, a first relay 23 connected to the terminal block 21, and a serial communication circuit 24 connected to the terminal block 21. The first relay 23 has a function for switching power transmission to the outdoor unit 3 and serial communication between the indoor unit 2 and the outdoor unit 3. In a case where a state of the first relay 23 is a state where the first relay 23 is caused to transmit power to the outdoor unit 3, that is, in a case where the state of the first relay 23 is a short-circuit state, an AC voltage is applied to the outdoor unit 3.

The indoor unit 2 further includes a capacitor 25 connected to the diode 22, a wiring line 26 that connects the diode 22 and the capacitor 25, and a medium voltage detection circuit 27 connected to the wiring line 26.

The outdoor unit 3 includes a terminal block 31 connected to the indoor unit 2. The air conditioner 1 further includes wiring lines 5, 6, and 7 that connect the terminal block 21 of the indoor unit 2 and the terminal block 31 of the outdoor unit 3. The outdoor unit 3 further includes a second relay 32 connected to the terminal block 31, a third relay 33 connected to the terminal block 31, and a serial communication circuit 34 connected to the third relay 33. The second relay 32 is in one of a short-circuit state or a released state, in accordance with a switching signal to be supplied. The third relay 33 has a function for switching power reception from the indoor unit 2 and the serial communication between the indoor unit 2 and the outdoor unit 3. The state of the first relay 23 is a state where the first relay 23 is caused to transmit power to the outdoor unit 3 and a state of the third relay 33 is a state where the third relay 33 is caused to receive power from the indoor unit 2, the AC voltage is applied to the outdoor unit 3. That is, in a case where each of the states of the first relay 23 and the third relay 33 is the short-circuit state, the AC voltage is applied to the inside of the outdoor unit 3.

The outdoor unit 3 further includes a power supply voltage detection circuit 35 connected to the terminal block 31 and a resistor 36 that connects the third relay 33 and the power supply voltage detection circuit 35. The power supply voltage detection circuit 35 is also connected to the second relay 32. The outdoor unit 3 further includes an AC/DC converter 37 connected to the terminal block 31, the second relay 32, the power supply voltage detection circuit 35, and the resistor 36. The AC/DC converter 37 has a function for converting the supplied AC voltage into a DC voltage. In FIG. 1, the AC/DC converter 37 is described as an “ACDC converter 37”. AC is an abbreviation for Alternating Current, and DC is an abbreviation for Direct Current. The AC/DC converter 37 includes four diodes 37a, 37b, 37c, and 37d.

The outdoor unit 3 further includes a capacitor 38 connected to the AC/DC converter 37 and an external voltage detection circuit 39 that detects a voltage. Specifically, the external voltage detection circuit 39 detects a voltage of the outdoor unit 3. The outdoor unit 3 further includes a DC/DC converter 40 connected to the capacitor 38. The DC/DC converter 40 has a function for converting a DC voltage having a certain value into a DC voltage having another value. In FIG. 1, the DC/DC converter 40 is described as a “DCDC converter 40”. The outdoor unit 3 further includes an intelligent power module 41 connected to the AC/DC converter 37, the capacitor 38, the external voltage detection circuit 39, and the DC/DC converter 40. In FIG. 1, the intelligent power module 41 is described as an “IPM 41”. The IPM is an abbreviation for Intelligent Power Module.

The outdoor unit 3 further includes an external protection relay switching circuit 42 connected to the external voltage detection circuit 39. The external voltage detection circuit 39 outputs a voltage signal indicating a detected voltage to the external protection relay switching circuit 42. In a case where the value of the voltage detected by the external voltage detection circuit 39 is larger than a predetermined first threshold, the external protection relay switching circuit 42 outputs a switching signal for causing the second relay 32 to be released, to the second relay 32.

Specifically, the external protection relay switching circuit 42 receives the voltage signal output from the external voltage detection circuit 39 and outputs a short-circuit release signal for switching short-circuit and release of the second relay 32, to the second relay 32, on the basis of the received voltage signal. More specifically, the short-circuit release signal is a signal for causing the second relay 32 to be in the short-circuit state or the released state. The second relay 32 receives the short-circuit release signal output from the external protection relay switching circuit 42 and is in one of the short-circuit state or the released state according to the received short-circuit release signal.

The outdoor unit 3 further includes a central processing unit 43 that outputs a driving signal for driving the external protection relay switching circuit 42 to the external protection relay switching circuit 42. In FIG. 1, the central processing unit 43 is described as a “CPU 43”. The CPU is an abbreviation for Central Processing Unit.

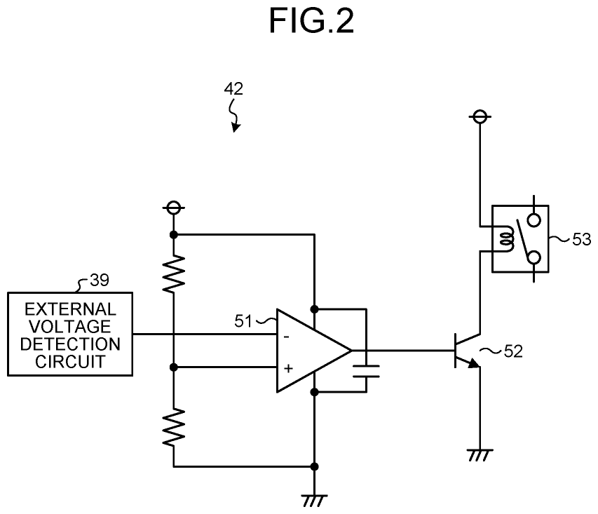

FIG. 2 is a diagram illustrating a configuration of the external protection relay switching circuit 42 included in the outdoor unit 3 of the air conditioner 1 according to the first embodiment. The external protection relay switching circuit 42 includes a voltage comparator 51 connected to the external voltage detection circuit 39, a switching element 52 that is connected to the voltage comparator 51 and receives a signal from the voltage comparator 51, and a relay 53 connected to the switching element 52. In FIG. 2, the external voltage detection circuit 39 is also illustrated.

The switching element 52 is turned on or off, in accordance with the driving signal output from the central processing unit 43. However, in a case where the voltage comparator 51 determines that a voltage indicated by the voltage signal output from the external voltage detection circuit 39 is an overvoltage, the voltage comparator 51 is turned on, and even if the driving signal output from the central processing unit 43 is a signal that turns on the switching element 52, the switching element 52 does not receive the driving signal output from the central processing unit 43 and is turned off.

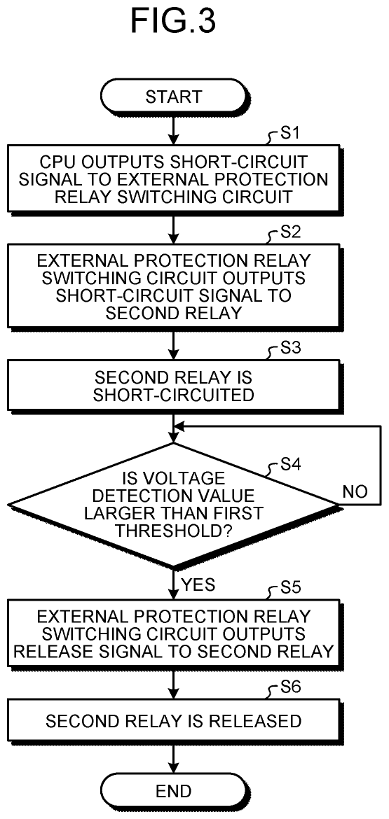

Next, an operation of the air conditioner 1 in a case where an anomaly of a power supply voltage occurs after the voltage is applied from the input power supply 4 and activation is performed, will be described. FIG. 3 is a flowchart illustrating a procedure of the operation performed by the air conditioner 1 according to the first embodiment. When the power supply voltage is applied, the air conditioner 1 starts the operation, and at the time of activation, the central processing unit 43 outputs a short-circuit signal to the external protection relay switching circuit 42 (S1). The short-circuit signal is a signal for short-circuiting the second relay 32. The external protection relay switching circuit 42 outputs the short-circuit signal to the second relay 32 (S2). The second relay 32 is short-circuited (S3). In FIG. 3, the central processing unit is described as a “CPU”.

During the operation of the air conditioner 1, the external protection relay switching circuit 42 determines whether or not the value of the voltage detected by the external voltage detection circuit 39 is larger than the first threshold (S4). The first threshold is a value used to determine whether or not the voltage detected by the external voltage detection circuit 39 is an overvoltage. More specifically, in a case where the voltage detected by the external voltage detection circuit 39 is the overvoltage, the value of the voltage detected by the external voltage detection circuit 39 is larger than the first threshold.

In a case of determining that the value of the voltage detected by the external voltage detection circuit 39 is larger than the first threshold (Yes in S4), the external protection relay switching circuit 42 outputs a release signal to the second relay 32 (S5). The second relay 32 is in the released state according to the release signal (S6). In a case of determining that the value of the voltage detected by the external voltage detection circuit 39 is equal to or less than the first threshold (No in S4), the external protection relay switching circuit 42 performs the operation in step S4 again.

As described above, the outdoor unit 3 included in the air conditioner 1 according to the first embodiment includes the second relay 32 that is in one of the short-circuit state or the released state according to the switching signal to be supplied, the external voltage detection circuit 39 that detects the voltage, and the external protection relay switching circuit 42 that outputs the switching signal for causing the second relay 32 to be in the released state in a case where the value of the voltage detected by the external voltage detection circuit 39 is larger than the predetermined first threshold, to the second relay 32.

That is, in the first embodiment, the voltage signal output from the external voltage detection circuit 39 is received by the external protection relay switching circuit 42 that is hardware, without passing through a CPU and a microcomputer, and the external protection relay switching circuit 42 outputs the switching signal for causing the second relay 32 to be in the released state in a case where the value of the voltage detected by the external voltage detection circuit 39 is larger than the predetermined first threshold, to the second relay 32. That is, in a case where the value of the detected voltage is larger than the first threshold, the application of the overvoltage to the outdoor unit 3 is interrupted.

Therefore, since the voltage signal output from the external voltage detection circuit 39 is received by the external protection relay switching circuit 42 that is hardware without passing through the CPU and the microcomputer, the air conditioner 1 can shorten time after the detection of the overvoltage to the interruption of the application of the overvoltage. As a result, in the air conditioner 1, it is possible to prevent components of the air conditioner 1 from being broken before the interruption of the application of the overvoltage.

### Second Embodiment

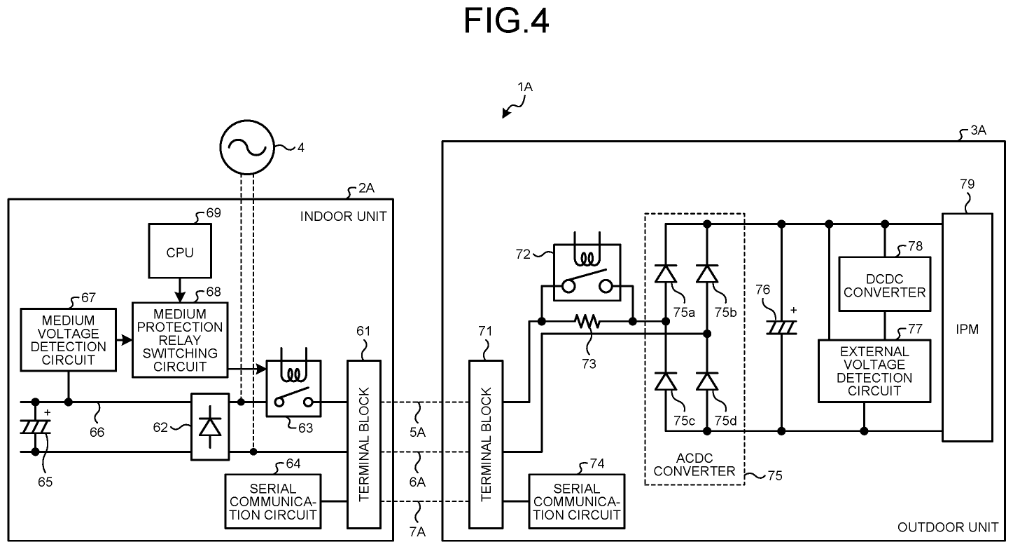

FIG. 4 is a diagram illustrating a configuration of an air conditioner 1A according to a second embodiment. The air conditioner 1A includes an indoor unit 2A and an outdoor unit 3A. The input power supply 4 that is the AC power supply is connected to the indoor unit 2A and the outdoor unit 3A. In FIG. 4, the input power supply 4 is also illustrated.

The indoor unit 2A includes a terminal block 61 connected to the outdoor unit 3A, a diode 62 connected to the terminal block 61, and a fourth relay 63 connected to the terminal block 61. The diode 62 is also connected to the fourth relay 63. The fourth relay 63 is in one of the short-circuit state or the released state, in accordance with the switching signal to be supplied. The indoor unit 2A further includes a serial communication circuit 64 connected to the terminal block 61, a capacitor 65 connected to the diode 62, a wiring line 66 that connects the diode 62 and the capacitor 65, and a medium voltage detection circuit 67 that is connected to the wiring line 66 and detects a voltage. The medium voltage detection circuit 67 detects a voltage of the indoor unit 2A.

The indoor unit 2A further includes a medium protection relay switching circuit 68 that outputs the switching signal for causing the fourth relay 63 to be in the released state in a case where a value of the voltage detected by the medium voltage detection circuit 67 is larger than the predetermined first threshold, to the fourth relay 63. More specifically, the medium protection relay switching circuit 68 outputs the short-circuit release signal for switching the short-circuit and the release of the fourth relay 63 to the fourth relay 63, on the basis of the detection result obtained by the medium voltage detection circuit 67. The short-circuit release signal is a signal for causing the fourth relay 63 to be in the short-circuit state or the released state. The fourth relay 63 receives the short-circuit release signal output from the medium protection relay switching circuit 68 and is in one of the short-circuit state or the released state according to the received short-circuit release signal.

The indoor unit 2A further includes a central processing unit 69 that outputs a driving signal for driving the medium protection relay switching circuit 68 to the medium protection relay switching circuit 68. In FIG. 4, the central processing unit 69 is described as a “CPU 69”. The air conditioner 1A applies the AC voltage to the outdoor unit 3A via the fourth relay 63.

The outdoor unit 3A includes a terminal block 71 connected to the indoor unit 2A. The air conditioner 1A further includes wiring lines 5A, 6A, and 7A that connect the terminal block 61 of the indoor unit 2A and the terminal block 71 of the outdoor unit 3A. The outdoor unit 3A further includes a fifth relay 72, a resistor 73, and a serial communication circuit 74. The fifth relay 72, the resistor 73, and the serial communication circuit 74 are connected to the terminal block 71. The resistor 73 is connected to both of two ends of the fifth relay 72.

The outdoor unit 3A further includes an AC/DC converter 75 connected to the terminal block 71, the fifth relay 72, and the resistor 73. The AC/DC converter 75 has a function for converting the supplied AC voltage into the DC voltage. In FIG. 4, the AC/DC converter 75 is described as an “ACDC converter 75”. The AC/DC converter 75 includes four diodes 75a, 75b, 75c, and 75d.

The outdoor unit 3A further includes a capacitor 76 connected to the AC/DC converter 75, an external voltage detection circuit 77 that detects a voltage of the capacitor 76, and a DC/DC converter 78 connected to the capacitor 76. The DC/DC converter 78 has a function for converting a DC voltage having a certain value into a DC voltage having another value. In FIG. 4, the DC/DC converter 78 is described as a “DCDC converter 78”. The outdoor unit 3A further includes an intelligent power module 79 connected to the AC/DC converter 75, the capacitor 76, the external voltage detection circuit 77, and the DC/DC converter 78. In FIG. 4, the intelligent power module 79 is described as an “IPM 79”.

A configuration of the medium protection relay switching circuit 68 included in the indoor unit 2A of the air conditioner 1A is the same as the configuration of the external protection relay switching circuit 42 in the first embodiment. That is, as illustrated in FIG. 2, the medium protection relay switching circuit 68 includes the voltage comparator 51, the switching element 52 that is connected to the voltage comparator 51 and receives a signal from the voltage comparator 51, and the relay 53 connected to the switching element 52. Note that, in the second embodiment, the external voltage detection circuit 39 in FIG. 2 is replaced with the medium voltage detection circuit 67. Therefore, in the second embodiment, the voltage comparator 51 is connected to the medium voltage detection circuit 67.

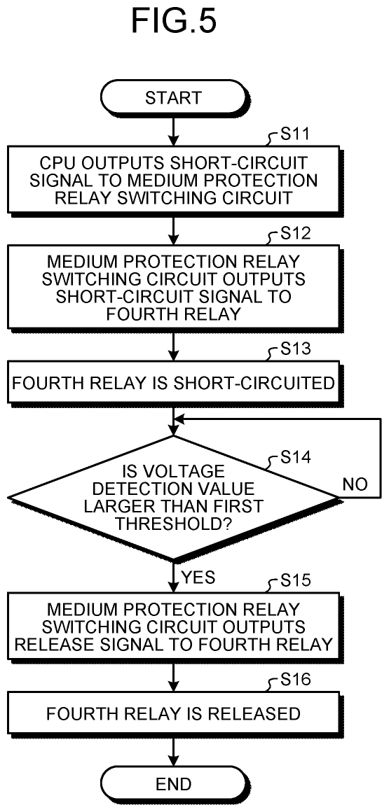

Next, an operation of the air conditioner 1A in a case where an anomaly of a power supply voltage occurs after the voltage is applied from the input power supply 4 and activation is performed, will be described. FIG. 5 is a flowchart illustrating a procedure of the operation performed by the air conditioner 1A according to the second embodiment. When the power supply voltage is applied, the air conditioner 1A starts the operation, and at the time of activation, the central processing unit 69 outputs a short-circuit signal to the medium protection relay switching circuit 68 (S11). The short-circuit signal is a signal for short-circuiting the fourth relay 63. The medium protection relay switching circuit 68 outputs the short-circuit signal to the fourth relay 63 (S12). The fourth relay 63 is short-circuited (S13). In FIG. 5, the central processing unit is described as a “CPU”.

During the operation of the air conditioner 1A, the medium protection relay switching circuit 68 determines whether or not the value of the voltage detected by the medium voltage detection circuit 67 is larger than the first threshold (S14). The first threshold is a value used to determine whether or not the voltage detected by the medium voltage detection circuit 67 is an overvoltage. More specifically, in a case where the voltage detected by the medium voltage detection circuit 67 is the overvoltage, the value of the voltage detected by the medium voltage detection circuit 67 is larger than the first threshold.

In a case of determining that the value of the voltage detected by the medium voltage detection circuit 67 is larger than the first threshold (Yes in S14), the medium protection relay switching circuit 68 outputs the release signal to the fourth relay 63 (S15). The fourth relay 63 is in the released state according to the release signal (S16). In a case of determining that the value of the voltage detected by the medium voltage detection circuit 67 is equal to or less than the first threshold (No in S14), the medium protection relay switching circuit 68 performs the operation in step S14 again.

As described above, the indoor unit 2A included in the air conditioner 1A according to the second embodiment includes the fourth relay 63 that is in one of the short-circuit state or the released state according to the switching signal to be supplied, the medium voltage detection circuit 67 that detects the voltage, and the medium protection relay switching circuit 68 that outputs the switching signal for causing the fourth relay 63 to be in the released state in a case where the value of the voltage detected by the medium voltage detection circuit 67 is larger than the predetermined first threshold, to the fourth relay 63.

That is, in the second embodiment, the voltage signal indicating the value of the voltage detected by the medium voltage detection circuit 67 is received by the medium protection relay switching circuit 68 that is hardware, without passing through the CPU and the microcomputer, and the medium protection relay switching circuit 68 outputs the switching signal for causing the fourth relay 63 to be in the released state in a case where the value of the voltage detected by the medium voltage detection circuit 67 is larger than the predetermined first threshold, to the fourth relay 63. That is, in a case where the value of the detected voltage is larger than the first threshold, the application of the overvoltage to the outdoor unit 3A is interrupted.

Therefore, since the voltage signal indicating the value of the voltage detected by the medium voltage detection circuit 67 is received by the medium protection relay switching circuit 68 that is hardware without passing through the CPU and the microcomputer, the air conditioner 1A can shorten the time after the detection of the overvoltage to the interruption of the application of the overvoltage. As a result, in the air conditioner 1A, it is possible to prevent components of the air conditioner 1A from being broken before the interruption of the application of the overvoltage.

The configurations indicated in the above embodiments indicate examples and can be combined with other known techniques. Furthermore, the embodiments can be combined with each other, and some configurations can be partially omitted or changed without departing from the gist.

1. An air conditioner including an indoor unit and an outdoor unit, the air conditioner comprising:
a switch to be in one of a short-circuit state or a released state according to a switching signal to be supplied;
a voltage detection circuit to detect a voltage and output a voltage signal indicating a voltage value obtained by the detection;
a switch switching circuit to output a switching signal for causing the switch to be in the released state in a case where a value indicated by the voltage signal output from the voltage detection circuit is larger than a predetermined first threshold, to the switch; and
a central processing unit to output a driving signal for driving the switch switching circuit to the switch switching circuit, wherein
the switch, the voltage detection circuit, and the switch switching circuit are disposed in the outdoor unit, and
the voltage signal is output to the switch switching circuit without passing through the central processing unit.

2. The air conditioner according to claim 1, further comprising a switch different from the switch.

3. The air conditioner according to claim 1, wherein
the switch switching circuit includes
a voltage comparator connected to the voltage detection circuit,
a switching element that is connected to the voltage comparator and receives a signal from the voltage comparator, and
a switch connected to the switching element.

4. The air conditioner according to claim 3, wherein
in a case where the voltage comparator determines that a voltage indicated by the voltage signal output from the voltage detection circuit is an overvoltage, the voltage comparator is turned on, and
even if the driving signal output from the central processing unit is a signal that turns on the switching element, the switching element is turned off.

5. An air conditioner including an indoor unit and an outdoor unit, the air conditioner comprising:
a switch to be in one of a short-circuit state or a released state according to a switching signal to be supplied;
a voltage detection circuit to detect a voltage and output a voltage signal indicating a voltage value obtained by the detection;
a switch switching circuit to output a switching signal for causing the switch to be in the released state in a case where a value indicated by the voltage signal output from the voltage detection circuit is larger than a predetermined first threshold, to the switch; and
a central processing unit to output a driving signal for driving the switch switching circuit to the switch switching circuit, wherein
the switch, the voltage detection circuit, and the switch switching circuit are disposed in the indoor unit, and
the voltage signal is output to the switch switching circuit without passing through the central processing unit.

6. The air conditioner according to claim 5, further comprising a switch different from the switch.

7. The air conditioner according to claim 5, wherein
the switch switching circuit includes
a voltage comparator connected to the voltage detection circuit,
a switching element that is connected to the voltage comparator and receives a signal from the voltage comparator, and
a switch connected to the switching element.

8. The air conditioner according to claim 7, wherein
in a case where the voltage comparator determines that a voltage indicated by the voltage signal output from the voltage detection circuit is an overvoltage, the voltage comparator is turned on, and
even if the driving signal output from the central processing unit is a signal that turns on the switching element, the switching element is turned off.
